(19) United States
(12) Patent Application Publication
(10) Pub. No.: US 2007/0035529 A1
(43) Pub. Date: Feb. 15, 2007

(54) Portable communication apparatus, and a method of controlling a user interface thereof

(75) Inventors: Henrik Balle, Copenhagen (DK); Thomas Pedersen, Fredriksberg (DK)

Correspondence Address: BANNER & WITCOFF, 1001 G STREET N W, SUITE 1100, WASHINGTON, DC, 20001, US

(73) Assignee: NOKIA CORPORATION, Espoo (FI)

(21) Appl. No.: 10/570,872

(22) PCT Filed: Sep. 15, 2003
(86) PCT No.: PCT/IB03/03926

§ 371 Date: Mar. 7, 2006

(51) Int. Cl. G09G 5/00

(52) U.S. Cl. 345/184

(57) ABSTRACT

A method of controlling a user interface of a portable communication apparatus (100) is disclosed. The user interface includes a display (240, 336) with a limited presentation area (352) and a manual input device (250, 338) with a rotary element (252). Graphical data to be presented is received and represents a required presentation area (500) larger than said limited presentation area. A first sub area (510) of said required presentation area is presented on said display. A first user input is accepted through said manual input device as a rotator rotary movement of said rotary element, indicating a desired navigation direction within said required presentation area. A second user input is accepted through said manual input device as a rotary movement of said rotary element, indicating a desired navigation distance within said required presentation area in said desired navigation direction. The second sub area (510′″) of said required presentation area is presented on said display, wherein the angular and vectorial displacement, respectively, of said second sub area with respect to said first sub area is determined by said first and second user input, respectively.

### FIELD OF THE INVENTION

The present invention relates to a portable communication apparatus with a controller and a user interface coupled to said controller, said user interface including a display and a manual input device, said display having a limited presentation area, said manual input device comprising a rotary element. Furthermore, the invention relates to a method of controlling the user interface of such an apparatus.

### BACKGROUND OF THE INVENTION

A mobile terminal in the form of a mobile (cellular) terminal for a telecommunications system like GSM, UMTS, D-AMPS or CDMA2000 is a familiar example of a portable communication apparatus according to the above.

WO02/39712 discloses an image control system for controlling a menu on a display in a television system. The menu comprises a plurality of simultaneously displayed menu items. A selector is arranged to select an item from the menu. A user input device comprises a control device for generating a control signal to move the selector relative to the menu. Further, a rotary control is disclosed, wherein rotation of the control causes a corresponding rotation of the menu. Alternatively, a cursor is viewed on the menu screen that follows the menu items as a user operates the control device.

More specifically, WO02/39712 discloses applicability to mobile telephone menus. The menu on a screen of a telephone handset is shown as a two-dimensional circle. A rotary dial is provided on the front face of the handset. The handset has the usual features of a mobile telephone with the addition of the rotary dial positioned on the front face. On activation of the menu of the mobile telephone handset, the dial operates as the control device described above with reference to the television system. Of course, there is no transmission of a remote control signal as in the television system; instead the signal is coupled to the display within the handset. To select an item from the menu a user rotates the dial until either the cursor has moved into association with the desired menu item or the menu has been rotated so that the desired item has come into alignment with a selector region on the screen of the mobile telephone handset.

U.S. Pat. No. 6,396,006 discloses a push and rotary operating type electronic device for a communication terminal. The mechanical and electrical design of this input device is described in detail. Again, the intended use of the device is specified as scrolling through menu items, etc, (rotary operation), followed by selection (push operation).

Thus, even if portable communication apparatuses having rotary input devices are known from the prior art, the practical use thereof is restricted to (circular/linear) scrolling through menu items or similar lists.

Almost all contemporary portable communication apparatuses have one thing in common: they have a small size and shape, due to strong market demands for miniaturization. An inherent problem is that the display will have a limited size too. A particular problem with a display of limited size is difficulties in presenting graphical data which represents a required presentation area larger than the available presentation area of the display. For instance, digital images are often provided in a size and resolution that require a larger presentation area than the available one.

The known approach to handle such situations is to down-scale (i.e., reduce the resolution of) the image to a size that fits within the available presentation area of the display. This approach has a drawback in the inevitable loss of resolution which is caused by the down-scaling. Such loss of resolution may cause loss of perceptivity of details in the image. There is a risk that important details, e.g. ones that represent vital information to the intended viewer, are lost or at least obscured.

As an alternative, the image may be scrolled step-wise in a conventional manner in down/up/left/right directions, much like the way in which a window is scrolled in a graphical user interface of a computer. Such four-directional or “arrow-key” scrolling is a rough manner of navigation; a large number of scrolling steps may be required in order to arrive at the desired portion of the graphical data to be presented.

### SUMMARY OF THE INVENTION

In view of the above, an objective of the invention is to solve or at least reduce the problems discussed above. In more particular, a purpose of the invention is to provide an improved and efficient manner of controlling the user interface of a portable communication apparatus, so that graphical data, requiring a presentation area which is larger than the available limited presentation area of the display, may be navigated and presented flexibly and accurately with few steps of manual intervention.

Generally, the above objectives are achieved by a portable communication apparatus and a method of controlling a user interface thereof according to the attached independent patent claims.

A first aspect of the invention is a method of controlling a user interface of a portable communication apparatus, said user interface including a display and a manual input device, said display having a limited presentation area, said manual input device comprising a rotary element, the method comprising the steps of:

receiving graphical data to be presented, wherein said graphical data represents a required presentation area which is larger than said limited presentation area of said display;

presenting a first sub area of said required presentation area on said display;

accepting a first user input through said manual input device in the form of a rotary movement of said rotary element, said first user input indicating a desired navigation direction within said required presentation area;

accepting a second user input through said manual input device in the form of a rotary movement of said rotary element, said second user input indicating a desired navigation distance within said required presentation area in said desired navigation direction; and

presenting a second sub area of said required presentation area on said display,

wherein the angular displacement of said second sub area with respect to said first sub area is determined by said first user input and wherein the vectorial displacement of said second sub area with respect to said first sub area is determined by said second user input.

One advantage with the first aspect of the invention is that it allows two-dimensional navigation in virtually all directions, in contrast to traditional navigation in merely four rectangular directions, in graphical data that requires a larger presentation area than is available. The actual number of selectable directions will of course depend on the resolution of the rotary element, i.e. the number of detectable steps of rotation that are included in one full 360° turn.

Another advantage is that such way of navigation will typically require less manual intervention (less number of navigation control inputs) than the traditional way.

Still one advantage is that the accuracy of navigation will be improved compared to traditional navigation. The user is more likely to arrive at the desired portion of the graphical data without mis-navigation, since the proposed invention allows for a more intuitive, albeit hitherto not recognized, way of navigation in the user interface of a portable communication apparatus.

One embodiment involves the further step, after said step of accepting a first user input, of accepting a third user input through said manual input device, wherein said third user input indicates a confirmation of the navigation direction as selected by said first user input.

One embodiment involves the further step, after said step of accepting a second user input, of accepting a fourth user input through said manual input device, wherein said fourth user input indicates a confirmation of the navigation distance as selected by said second user input.

The third and fourth user inputs may be accepted in the form of respective selections of a key element included in said manual input device. The key element may be a depressible key positioned adjacently to said rotary element. The third and fourth user inputs may also be accepted in the form of respective selections of a depressible rim section of said rotary element. To avoid confusion, it is to be noticed that the first to fourth user inputs are not made in the order first-second-third-fourth but rather first-third-second-fourth.

As an alternative to said third and fourth user inputs, confirmation of said selected navigation direction and said selected navigation distance, respectively, may be effected by activating a timeout function when a predetermined time has elapsed since the last manual input. In other words, if the user has not performed any additional rotational movement for a given time, it is assumed that the current input is what the user intends and desires.

In one embodiment the method is applied to a portable communication apparatus which further comprises a wireless communication interface, wherein said graphical data to be presented is received over said wireless communication interface. The wireless communication interface may be at least one of a short-range supplementary radio data interface such as Bluetooth; a short-range infrared data interface such as IrDA; a WAP compatible interface; a HTTP compatible interface; and an RF interface for a mobile telecommunications system such as GSM, UMTS, D-AMPS or CDMA2000.

The graphical data to be presented may be a digital image. Furthermore, the graphical data to be presented may pertain to hypertext data such as hypertext markup language data (HTML) or wireless markup language data (WML).

The graphical data to be presented need not necessarily have to be received from an external source (e.g. through aforesaid wireless communication interface); it may alternatively originate from the portable communication apparatus itself. For instance, an image may be captured by a local integrated camera and stored in local memory as graphical data to be presented.

In one embodiment, during input of said second user input, the vectorial displacement of said second sub area with respect to said first sub area is repeatedly determined and an updated second sub area is responsively presented on said display. A position indicator may be shown within said second sub area to indicate its current vectorial displacement. In one embodiment said position indicator is shown at the center of said second sub area.

Particularly when said graphical data to be presented pertains to hypertext data, it may further be determined whether said position indicator coincides with a hyperlink, whereupon, in response to accepting a fifth user input through said manual input device, said hyper-link may be activated. Hence, there is provided an expedient manner of navigation through e.g. a WAP or WWW page (WML or HTTP document) with the concurrent option of exploring hyperlinks at the user's desire.

A second aspect of the invention is a portable communication apparatus with a controller and a user interface coupled to said controller, said user interface including a display and a manual input device, said display having a limited presentation area, said manual input device comprising a rotary element. The portable communication apparatus further has:

means for receiving graphical data to be presented, wherein said graphical data represents a required presentation area which is larger than said limited presentation area of said display;

means for presenting a first sub area of said required presentation area on said display;

means for accepting a first user input through said manual input device in the form of a rotary movement of said rotary element, said first user input indicating a desired navigation direction within said required presentation area;

means for accepting a second user input through said manual input device in the form of a rotary movement of said rotary element, said second user input indicating a desired navigation distance within said required presentation area in said desired navigation direction;

means for determining, from said first user input, an angular displacement of a second sub area of said required presentation area with respect to said first sub area;

means for determining, from said second user input, a vectorial displacement of said second sub area with respect to said first sub area; and

means for presenting said second sub area on said display.

The portable communication apparatus may be a mobile terminal for a mobile telecommunications system, such as GSM, UMTS, D-AMPS or CDMA2000, or a portable digital assistant (PDA), or another type of similar device.

The second aspect has generally the same advantages as the first aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The present invention will now be described in more detail, reference being made to the enclosed drawings, in which:

FIG. 1 is a schematic illustration of a telecommunications system, including a portable communication apparatus in the form of a mobile terminal, as an example of an environment in which the present invention may be applied.

FIG. 2 is a schematic perspective view of the portable communication apparatus of FIG. 1, illustrating in more detail its user interface which includes a limited-sized display and a manual input device having a rotary element.

FIG. 3 is a schematic block diagram illustrating the internal structure of a portable communication apparatus according to FIGS. 1 and 2 in more detail.

FIG. 4 is a flow chart which illustrates one embodiment of a method of controlling a user interface of a portable communication apparatus.

FIGS. 5a-5d illustrate how a sub area of a larger presentation area than is available is selected and presented on a limited-sized display according to one embodiment.

### DETAILED DESCRIPTION OF THE INVENTION

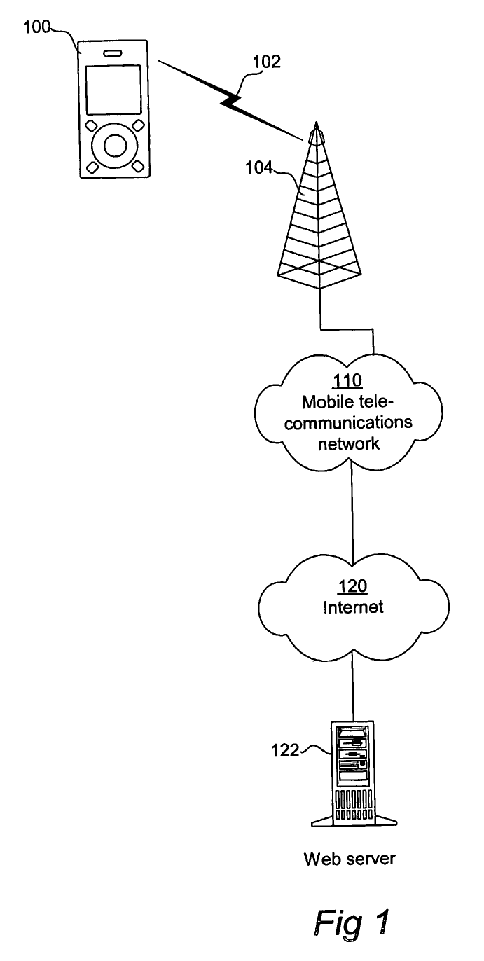

First, with reference to FIG. 1, one example of a telecommunications system in which the invention may be applied will be briefly described.

In the telecommunications system of FIG. 1, various telecommunications services such as voice calls, data calls, facsimile transmissions, music transmissions, still image transmissions, video transmissions, electronic message transmissions and electronic commerce may be performed by way of a portable communication apparatus or mobile terminal 100. The portable communication apparatus 100 is connected to a mobile telecommunications network 110 through an RF link 102 via a base station 104, as is well known in the art. The mobile telecommunications network 110 may be any commercially available mobile telecommunications system, such as GSM, UMTS, D-AMPS or CDMA2000. The portable communication apparatus 100 is illustrated as a mobile (cellular) telephone but may alternatively be another kind of portable device, such as a portable digital assistant (PDA) or a communicator.

The mobile telecommunications network 110 is operatively connected to a wide area network 120, which may be Internet or a part thereof. A web server 122 is connected to the wide area network 120 and may be accessed, in accordance with specified protocols (such as TCP, IP and HTTP), from the portable communication apparatus 100 through appropriate client software therein (such as a WAP or WWW browser).

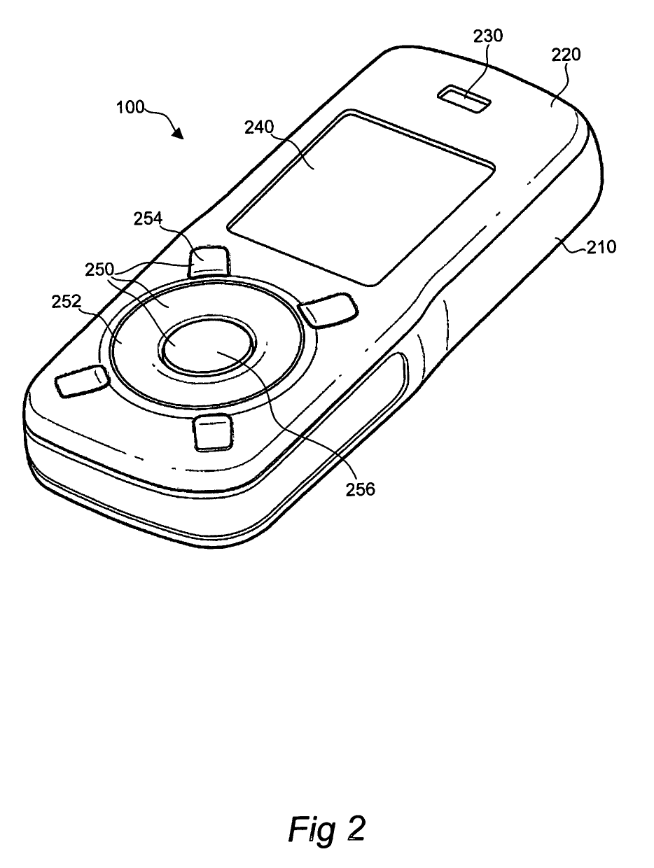

FIG. 2 illustrates one embodiment of a portable communication apparatus 100 according to the invention. In the embodiment shown in FIG. 1, the portable communication apparatus 100 is a mobile telephone having an apparatus housing 210. A front surface 220 of the portable communication apparatus 100 has a speaker opening 230 and a display 240. The front surface 220 will face the user of the apparatus 100 during normal operation, as is well known in the art.

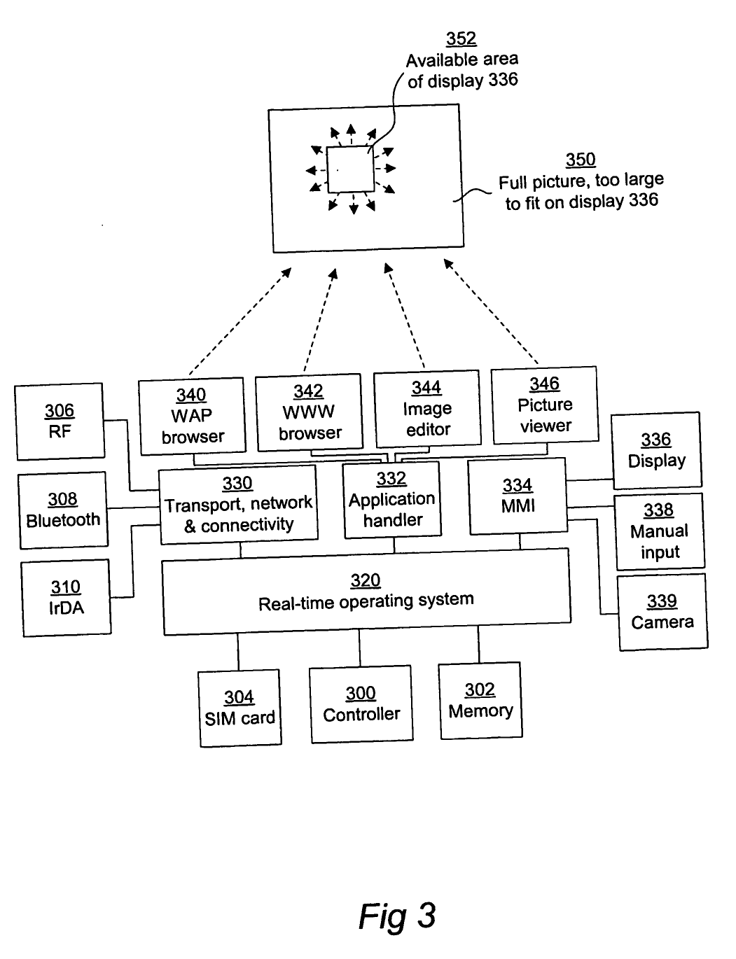

The apparatus 100 also has a manual input device 250 which is accessible to the user at the front surface 220 and by means of which the user may control the mobile telephone through manual input. As seen in FIG. 2, the manual input device 250 includes a rotary element (“rotator”) 252, which may be rotated by the user's finger for various purposes, such as scrolling between different menus or menu options in the operating system and/or applications, for controlling the position of a cursor on the display 140, for selecting different elements of a palette of characters, digits, letters, colors, setting values, etc. Central to the present invention, though, is one particular use of the rotary element 252: as an input means for controlling navigation in graphical data, the required presentation area of which exceeds the available presentation area of the display 240. The rotary element 252 has a mechanical arrangent, not shown in the drawings, which allows rotation of the rotary element in the plane of the front surface 220, detection of a current position of the rotary element and generation of a signal to a controller (e.g. controller 300 of FIG. 3), wherein the signal is representative of the detected position. The position may for instance be detected optically, magnetically or electromechanically. This mechanical arrangent, which may include a top ring, an encoder and a bearing module, is no central part of the invention, and various existing rotary input devices may be used to implement the rotary element 252.

As seen further in FIG. 2, the manual input device 250 comprises a center key 256 disposed in a central opening of the rotary element 252. The center key 256 may be arranged to function as a five-way key, being depressible at four peripheral positions which represent directions “north”, “south”, “east” and “west” as well as at a central position to represent “down”/“select”/“ok”/“enter”.

Additionally, the manual input device 250 comprises a set of additional keys 254 which are equidistantly disposed adjacently to an outer perimeter of the rotary element 252. The additional keys 254 may have different preprogrammed functions in different applications. The rotary element 252 may have a rim section which is depressible towards the front surface 220, i.e. in the same direction as the additional keys 254. By depressing the rim section at different points around the circumference of the rotary element 252, the user may select different preprogrammed functions, as is the case with the additional keys 254.

FIG. 3 illustrates the internal structure of the portable communication apparatus 100. A controller 300 is responsible for the overall operation of the portable communication apparatus and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the portable communication apparatus. The software includes a real-time operating system 320, man-machine interface (MMI) drivers 334, an application handler 332 as well as various applications. The applications include a WAP browser 340, a WWW browser 342, an image editor 344 and a picture viewer 346, as well as various other applications which are not referred to herein. The MMI drivers 334 cooperate with various MMI or input/output (I/O) devices, including the display 336 (corresponding to element 240 of FIG. 2) and the manual input device 338 (corresponding to elements 250-256 of FIG. 2) as well as various other I/O devices such as a camera 339, a microphone, a speaker, a vibrator, a joystick, a ringtone generator, an LED indicator, etc. As is commonly known, a user may operate the portable communication apparatus through the man-machine interface thus formed.

The software also includes various modules, protocol stacks, drivers, etc., which are commonly designated as 330 and which provide communication services (such as transport, network and connectivity) for an RF interface 306, a Bluetooth interface 308 and an IrDA interface 310. The RF interface 306 comprises an internal or external antenna as well as appropriate radio circuitry for establishing and maintaining a wireless link to a base station (e.g. link 102 to base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The portable communication apparatus also has a SIM card 304 and an associated reader. As is commonly known, the SIM card 304 comprises a processor as well as local work and data memory.

As seen in FIG. 3, several applications (WAP browser 340, WWW browser 342, image editor 344 and picture viewer 346) may and will present graphical data to the user of the portable communication apparatus. For instance, the WAP browser 340 and the WWW browser 342 will receive graphical data, in the form of hypertext data that represents a WAP or WWW page (i.e., a WML or HTML document), and present such a WAP or WWW page on the display 336. Furthermore, graphical data in the form of a digital image—which for instance has been captured by the camera 339, downloaded from an external source (e.g. the web server 122 or another source on the Internet 120, or through any other communication interface 306-310) or generated locally in the apparatus 100 by e.g. the image editor 344—will be received by image editor 344 or picture viewer 346 and presented on the display 336.

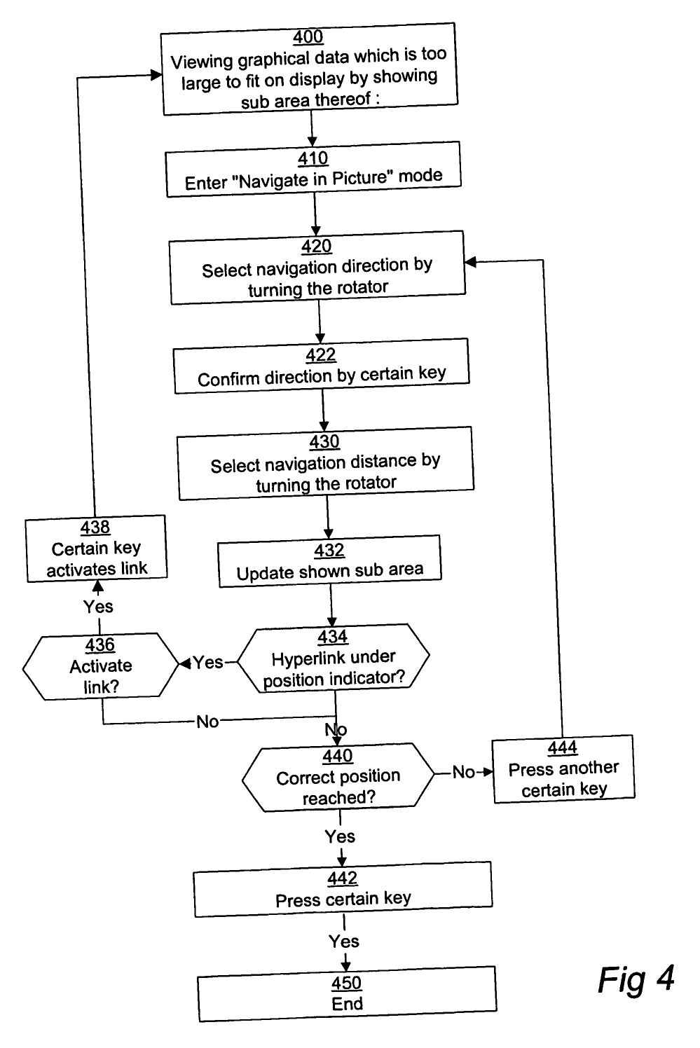

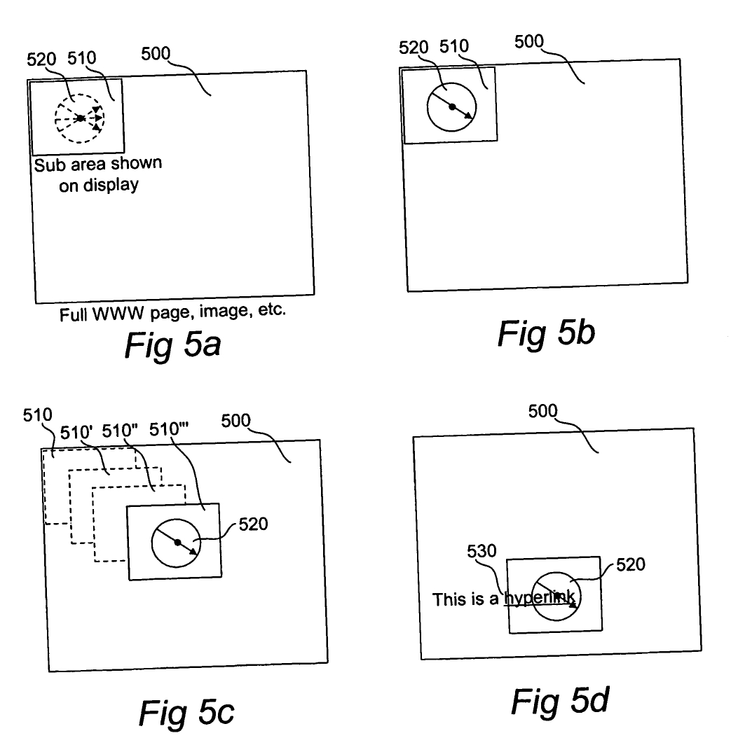

Whenever such graphical data requires a presentation area 350 which is too large to fit in the available presentation area 352 of the display 336, the display navigation method of the present invention may be used, as will be described in more detail below with reference to FIGS. 4 and 5. In summary, initially a sub area of the required presentation area 350 will be shown on the display 336, wherein the sub area is positioned at a start position, such as the uppermost/leftmost part of the required presentation area 350, and wherein the size of the sub area preferably corresponds to the size of the available presentation area 352 of the display 336. To navigate within the required presentation area 350, by rotation of the rotary element 252, the user will select a desired pan direction for the sub area to be presented.

Then, again by rotation of the rotary element 252, the user will select a desired scrolling distance, in the selected direction within the required presentation area 350, for the sub area to be presented. In response, the selected sub area of the required presentation area 352, located at the position determined by the selected direction and distance, will be presented on the display 336.

Reference is now made to the flow chart of FIG. 4 and the associated display illustrations shown in FIGS. 5a-5d. FIG. 4 illustrates one exemplary method 400 of navigating in a large presentation area for graphical data by successively selecting and presenting different sub areas of the total presentation area. In FIG. 4 it is assumed that one of the WAP browser 340, WWW browser 342, image editor 344 or picture viewer 346 is active in the portable communication apparatus 100 and that such active application has received graphical data to be presented on the display 336. More specifically, in line with the foregoing discussion it is assumed that the received graphical data requires a presentation area 500 (FIG. 5a-d) which is larger than the available presentation area of the display.

In step 410, the user of the portable communication apparatus 100 enters a display navigation mode which may be referred to as “Navigate in Picture”. This mode may be selected in various ways, for instance by long press on a certain key 254 or 256 (or on a certain point on a depressible rim section of the rotary element 252), selection of a certain menu item, etc. Upon entry into this mode, a sub area 510 of the full required presentation area 500 is shown on the display 336. As seen in FIG. 5a, the sub area 510 relates to a certain start position, such as the upper left corner area of the full presentation area 500. A position indicator 520 is shown at the center of the presented sub area 510. As seen in FIG. 5a, the position indicator 520 may have the appearance of a dial with a center arrow and may be blinking or otherwise highlighted to indicate to the user that a manual input is required.

In step 420 the user may select a desired picture navigation direction by turning the rotary element 252 of the manual input device 250. In response, the angular position of the center arrow is updated, as shown in FIG. 5a by a plurality of dashed arrows. Once the desired direction has been reached, the user may confirm the selection by pressing a certain key 254 or 256 (or a certain point on a depressible rim section of the rotary element 252) in step 422. In response, the appearance of the position indicator 520 changes from blinking, etc., to stationary, as indicated by solid lines in FIG. 5b.

Now, in step 430, the user may select a desired picture navigation distance, again by turning the rotary element 252 of the manual input device 250. As the rotary element 252 is turned, new sub areas 510′, 510″ of the full presentation area 500 may be determined along the selected navigation direction and shown sequentially on the display 336 (step 432), until the user arrives at the desired navigation distance and confirms the selection (steps 440, 442) by pressing a certain key 254 or 256 (or a certain point on a depressible rim section of the rotary element 252). The thus selected sub area 510′″ remains on the display 336, until the user again enters the Navigate in Picture mode or selects another action. If the user is not satisfied with the navigation distance and sub area thus reached, he may press another certain key 254 or 256 (or a certain point on a depressible rim section of the rotary element 252) in step 444 in order to return to step 420 and be given a new opportunity of selecting a navigation direction.

As shown in FIG. 5d, if during aforesaid distance scroll the position indicator (particularly the center thereof) coincides with a hyperlink or another selectable item in the presented graphical data, the hyperlink, etc., may be activated/followed by pressing a certain key 254 or 256 (or a certain point on a depressible rim section of the rotary element 252) in steps 434-438.

The invention has mainly been described above with reference to one embodiment. However, as is readily appreciated by a person skilled in the art, other embodiments than the one disclosed above are equally possible within the scope of the invention, as defined by the appended patent claims.

1. A method of controlling a user interface of a portable communication apparatus, said user interface including a display and a manual input device, said display having a limited presentation area, said manual input device comprising a rotary element, the method comprising the steps of:
receiving graphical data to be presented, wherein said graphical data represents a required presentation area which is larger than said limited presentation area of said display;
presenting a first sub area of said required presentation area on said display;
accepting a first user input through said manual input device in the form of a rotary movement of said rotary element, said first user input indicating a desired navigation direction within said required presentation area;
accepting a second user input through said manual input device in the form of a rotary movement of said rotary element, said second user input indicating a desired navigation distance within said required presentation area in said desired navigation direction; and
presenting a second sub area of said required presentation area on said display, wherein the angular displacement of said second sub area with respect to said first sub area is determined by said first user input and wherein the vectorial displacement of said second sub area with respect to said first sub area is determined by said second user input.

2. A method as in claim 1, comprising the further step, after said step of accepting a first user input, of:
accepting a third user input through said manual input device, wherein said third user input indicates a confirmation of the navigation direction as selected by said first user input.

3. A method as in claim 2, comprising the further step, after said step of accepting a second user input, of:
accepting a fourth user input through said manual input device, wherein said fourth user input indicates a confirmation of the navigation distance as selected by said second user input.

4. A method as in claim 3, wherein said third and fourth user inputs are accepted in the form of respective selections of a key element included in said manual input device.

5. A method as in claim 1, said portable communication apparatus further comprising a wireless communication interface, wherein said method further comprises receiving over said wireless communication interface said graphical data to be presented.

6. A method as in claim 5, wherein said wireless communication interface is at least one of:
a short-range supplementary radio data interface;
a short-range infrared data interface;
a WAP compatible interface;
a HTTP compatible interface; and
an RF interface for a mobile telecommunications system.

7. A method as in claim 1, wherein said graphical data to be presented comprises a digital image.

8. A method as in claim 1, wherein said graphical data to be presented pertains to hypertext data such as hypertext markup language data (HTML) or wireless markup language data (WML).

9. A method as in claim 1, wherein, during input of said second user input, the vectorial displacement of said second sub area with respect to said first sub area is repeatedly determined and an updated second sub area is responsively presented on said display.

10. A method as in claim 9, wherein a position indicator is shown within said second sub area to indicate its current vectorial displacement.

11. A method as in claim 10, wherein said position indicator is shown at the center of said second sub area.

12. A method as in claim 1, wherein said graphical data to be presented pertains to hypertext data such as hypertext markup language data (HTML) or wireless markup language data (WML);
wherein, during input of said second user input, the vectorial displacement of said second sub area with respect to said first sub area is repeatedly determined and an updated second sub area is responsively presented on said display;
wherein a position indicator is shown within said second sub area to indicate its current vectorial displacement; and
further comprising the steps of:
determining whether said position indicator coincides with a hyperlink; and
in response to accepting a fifth user input through said manual input device, activating said hyperlink.

13. A portable communication apparatus, comprising:
a controller;
a user interface coupled to said controller, said user interface including a display and a manual input device, said display having a limited presentation area, said manual input device comprising a rotary element;
means for receiving graphical data to be presented, wherein said graphical data represents a required presentation area which is larger than said limited presentation area of said display;
means for presenting a first sub area of said required presentation area on said display;
means for accepting a first user input through said manual input device in the form of a rotary movement of said rotary element, said first user input indicating a desired navigation direction within said required presentation area;
means for accepting a second user input through said manual input device in the form of a rotary movement of said rotary element, said second user input indicating a desired navigation distance within said required presentation area in said desired navigation direction;
means for determining, from said first user input, an angular displacement of a second sub area of said required presentation area with respect to said first sub area;
means for determining, from said second user input, a vectorial displacement of said second sub area with respect to said first sub area; and
means for presenting said second sub area on said display.

14. A portable communication apparatus as in claim 13, in the form of a mobile terminal for a mobile telecommunications system.

15. A portable communication apparatus as in claim 13, in the form of a portable digital assistant (PDA).

16. A method as in claim 3, wherein said third and fourth user inputs are accepted in the form of respective selections of a depressible rim section of said rotary element.

17. One or more computer readable media storing computer executable instructions for performing a method of controlling a user interface of a portable communication apparatus, said method comprising steps of:
a controller;
a user interface coupled to said controller, said user interface including a display and a manual input device, said display having a limited presentation area, said manual input device comprising a rotary element;
receiving graphical data to be presented, wherein said graphical data represents a required presentation area which is larger than a limited presentation area of a display of the portable communication apparatus;
presenting a first sub area of said required presentation area on said display;
accepting a first user input through a manual input device of the portable communication apparatus in the form of a rotary movement of a rotary element of the manual input device, said first user input indicating a desired navigation direction within said required presentation area;
accepting a second user input through said manual input device in the form of a rotary movement of said rotary element, said second user input indicating a desired navigation distance within said required presentation area in said desired navigation direction;
determining, from said first user input, an angular displacement of a second sub area of said required presentation area with respect to said first sub area;
determining, from said second user input, a vectorial displacement of said second sub area with respect to said first sub area; and
presenting said second sub area on said display.

18. The computer readable media of claim 17, said method further comprising:
receiving the graphical data over a wireless communication interface.

19. The computer readable media of claim 18, wherein said wireless communication interface comprises one of a GSM interface and a CDMA interface.

20. The computer readable media of claim 17, said method further comprising repeatedly determining, during input of said second user input, the vectorial displacement of said second sub area with respect to said first sub area; and
responsively presenting an updated second sub area on said display.
